(19) United States
(12) Patent Application Publication
(10) Pub. No.: US 2019/0183099 A1
(43) Pub. Date: Jun. 20, 2019

(54) Direct Current Pump

(71) Applicant: Yu-Cheng Lin, Taichung City (TW)

(72) Inventor: Yu-Cheng Lin, Taichung City (TW)

(21) Appl. No.: 16/214,227

(22) Filed: Dec. 10, 2018

(30) Foreign Application Priority Data
Dec. 15, 2017 (TW) 106144222

(51) Int. Cl. A01K 63/04; F04D 29/40; F04D 29/60; F04D 13/06

(52) U.S. Cl. CPC A01K 63/042; F04D 29/403; F04B 35/04; F04D 13/068; F04D 29/601

(57) ABSTRACT

A direct current pump contains a case, a pumping module, a switch assembly, and a slidable holder. The case is integrally formed, having an accommodation chamber and an opening communicating with the accommodation chamber. The pumping module is received in the accommodation chamber and includes a motor and a pump. The switch assembly is received in the accommodation chamber and is electrically connected to the motor. The switch assembly includes a button for turning on/off the motor. The slidable holder covers onto the opening and is received in the accommodation chamber. The slidable holder includes a receiving portion for a battery assembly to be received therein.

### FIELD OF THE INVENTION

The present invention relates to a direct current pump which can prevent the water spilled on the case from flowing or seeping into the case of the pump.

### BACKGROUND OF THE INVENTION

Conventional air pumps are applied for pumping air into water of fish buckets.

Referring to FIGS. 1-3, a conventional air pump comprises a case 10 which includes an open spaced first accommodation portion 101 and an open spaced second accommodation portion 102. The first accommodation portion 101 has a pumping element 11 and a motor 12 received therein. The pumping element 11 has an elastic cap 111 and an air exhaust tube 112 protruding and extending out of a top surface of the case 10. The motor 12 repeatedly compresses and releases the cap 111 to pump air, pumping the air into the water via the air exhaust tube 112. The second accommodation portion 102 of the case 10 has a battery assembly 13 received therein. The case 10 includes a water resisting lid 141 fixed on the top surface thereof and includes a switch 14 electrically connected to the motor 12 and the battery assembly 13 so as to control the operation of the motor 12. The case 10 further includes a first covering plate 103 configured to cover the first accommodating portion 101 and includes a second covering plate 104 configured to cover the second accommodating portion 102.

Referring to FIGS. 2-4, the conventional air pump can be coupled to a fish bucket 20. The air exhaust tube 112 of the pumping element 11 is directed into the water contained in the fish bucket 20 via a pipe 21. The cap 111 of the pumping element 11 is compressed and released by the motor 12 to pump the air repeatedly after the motor 12 is turned on. The air is then pumped into the water via the air exhaust tube 112 and the pipe 21, supplying oxygen into the water contained in the fish bucket 20.

The switch 14 of the case 10 and the air exhaust tube 112 of the pumping element 11 are put upwardly for the users to operate the conventional air pump easily. However, when user fills the fish bucket 20 with water, the case 10 is unavoidably spilled or poured by the water. The water may seep or flow into the case 10 via the slit between the accommodation portions and the covering plates, causing short circuit of the motor 12, the battery assembly 13, and the switch 14.

To overcome the above-mentioned problem, water resisting rubber strap may be provided to the slits between the accommodation portions and the covering plates and between the air exhaust tube 112 and the case 10. However, the added strap can make the fabrication of the pump complicated, increasing fabrication cost.

The present invention has arisen to mitigate and/or obviate the afore-described disadvantages.

### SUMMARY OF THE INVENTION

The primary aspect of the present invention is to provide a direct current pump which can resist water, blocking water out when water is spilled thereon.

Another aspect of the present invention is to provide a direct current pump wherein the battery assembly thereof can be replaced easily.

To obtain above-mentioned aspects, a direct current pump provided by the present invention contains a case, a pumping module, a switch assembly, and a slidable holder.

The case is integrally formed, having a top plate, a first side plate, a second side plate, a third side plate, and a fourth side plate. The top plate is formed on a top surface of the case. The first side plate and the second side plate are connected to two sides of the top plate respectively. The third side plate is connected to the top plate, the first side plate, and the second side plate. The fourth side plate is connected to the top plate, the first side plate, and a second side plate and being opposite to the third side plate. The case has an accommodation chamber defined therein and an opening defined on a bottom surface of the case. The opening communicates with the accommodation chamber.

The pumping module is received in the accommodation chamber of the case. The pumping module includes a motor and a pump driven by the motor to pump air.

The switch assembly is received in the accommodation chamber of the case and is electrically connected to the motor of the pumping module. The switch assembly includes a button protruding out of the case.

The slidable holder is covered onto the opening of the case and is received in the accommodation chamber of the case. The slidable holder includes a receiving portion adapted for a battery assembly to be received therein.

### BRIEF DESCRIPTION OF THE DRAWINGS

FIG. 1 is a perspective view showing the exploded components of a conventional air pump.

FIG. 2 is a perspective view showing the assembly of the conventional air pump.

FIG. 3 is a cross sectional view showing the assembly of the conventional air pump.

FIG. 4 is a perspective view showing the application of the conventional air pump.

FIG. 5 is a perspective view showing the exploded components of a direct current pump according to a preferred embodiment of the present invention.

FIG. 6 is a perspective view showing the assembly of the direct current pump according to the preferred embodiment of the present invention.

FIG. 7 is a cross sectional view taken along the line A-A of FIG. 5.

FIG. 8 is a cross sectional view taken along the line B-B of FIG. 5.

FIG. 9 is a perspective view showing the application of the direct current pump according to the preferred embodiment of the present invention.

FIG. 10 is another perspective view showing the application of the direct current pump according to the preferred embodiment of the present invention.

FIG. 11 is a cross sectional view showing the application of the direct current pump according to the preferred embodiment of the present invention.

FIG. 12 is a cross sectional view showing the operation of the direct current pump according to the preferred embodiment of the present invention.

FIG. 13 is another cross sectional view showing the operation of the direct current pump according to the preferred embodiment of the present invention.

FIG. 14 is a perspective view showing the operation of the direct current pump according to the preferred embodiment of the present invention.

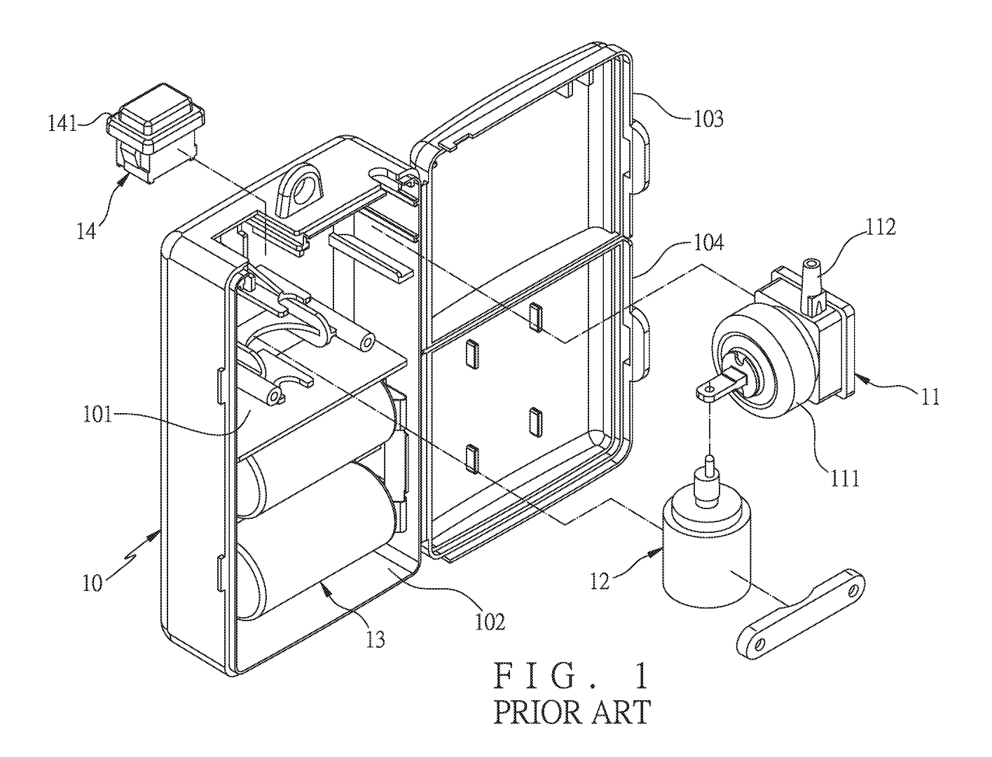

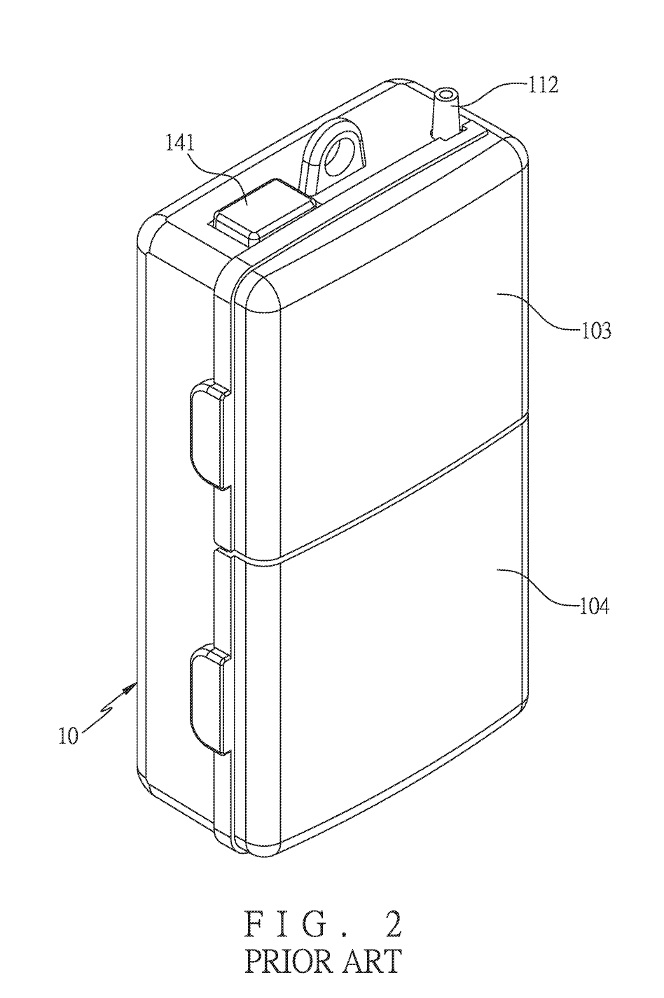

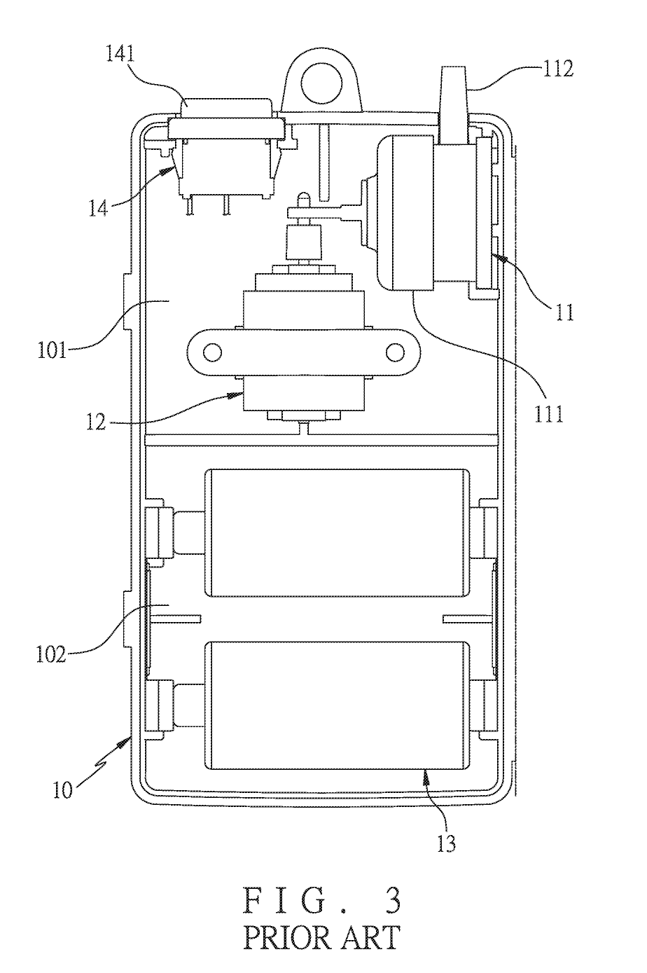

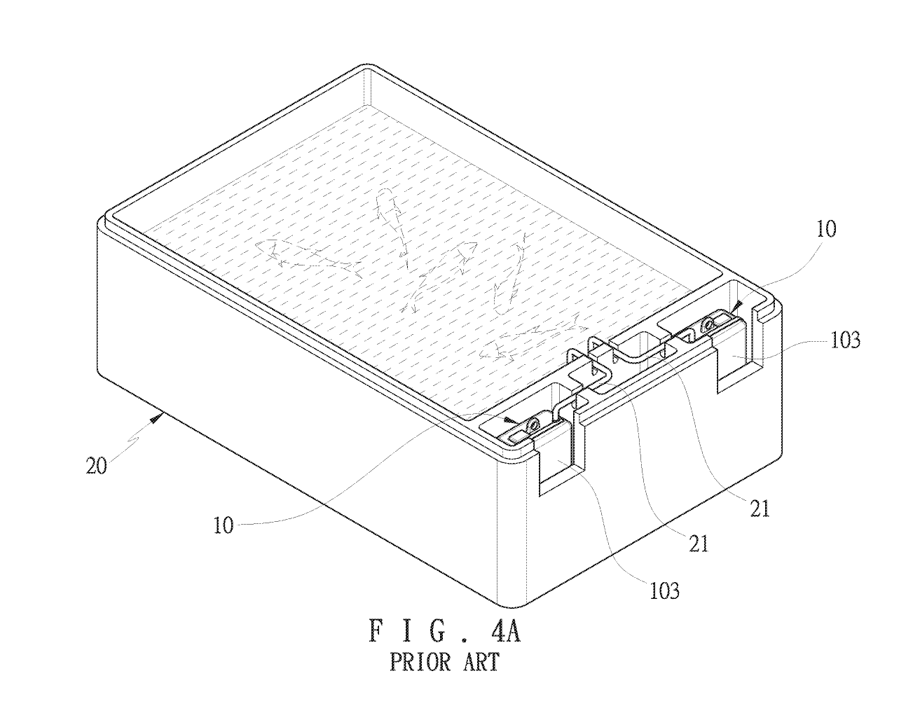

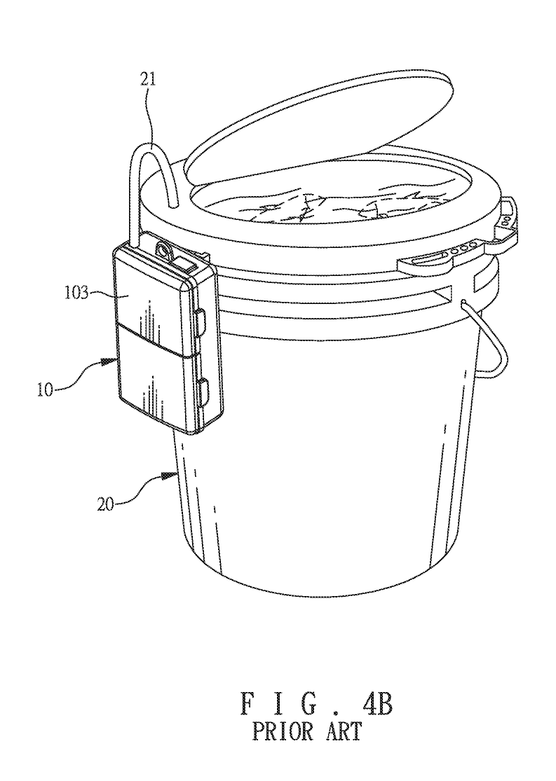

### DETAILED DESCRIPTION OF THE PREFERRED EMBODIMENTS

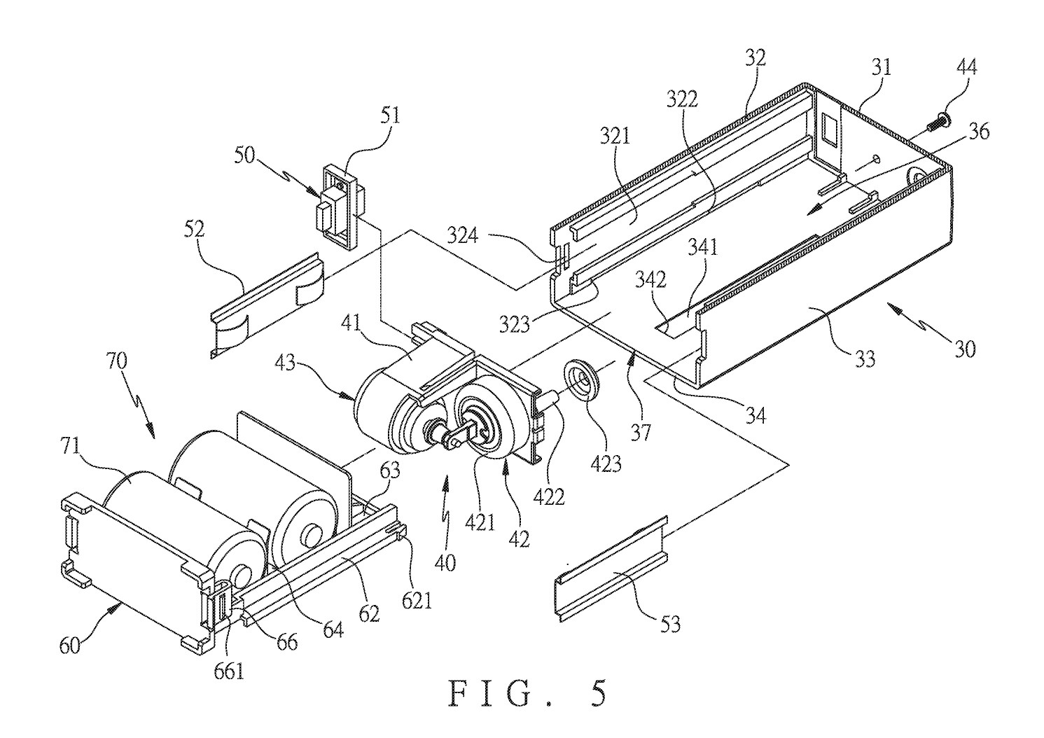

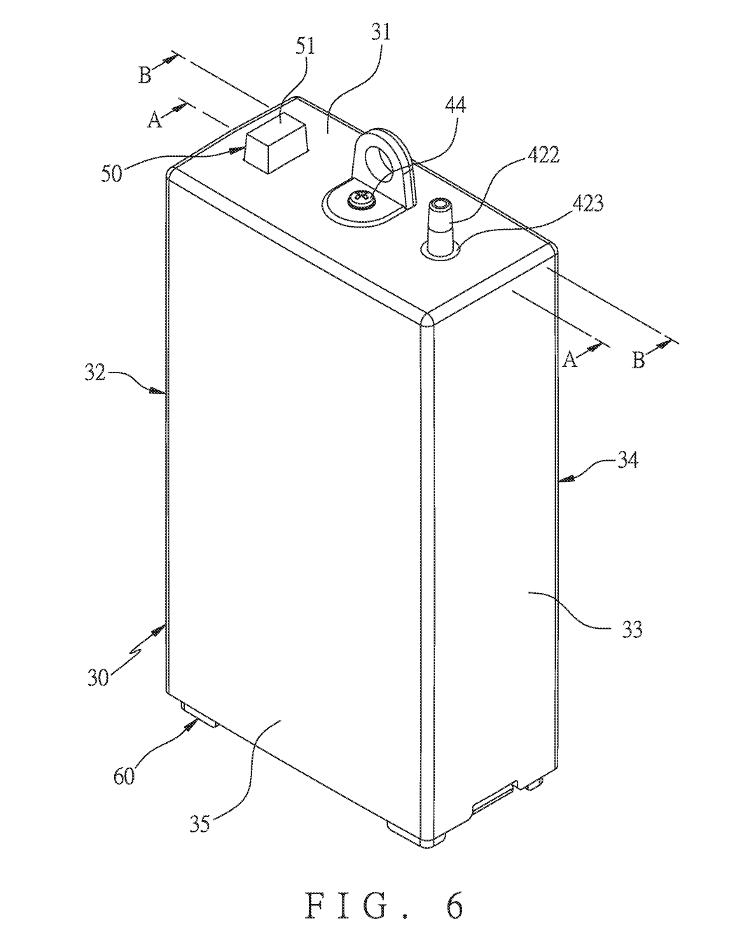

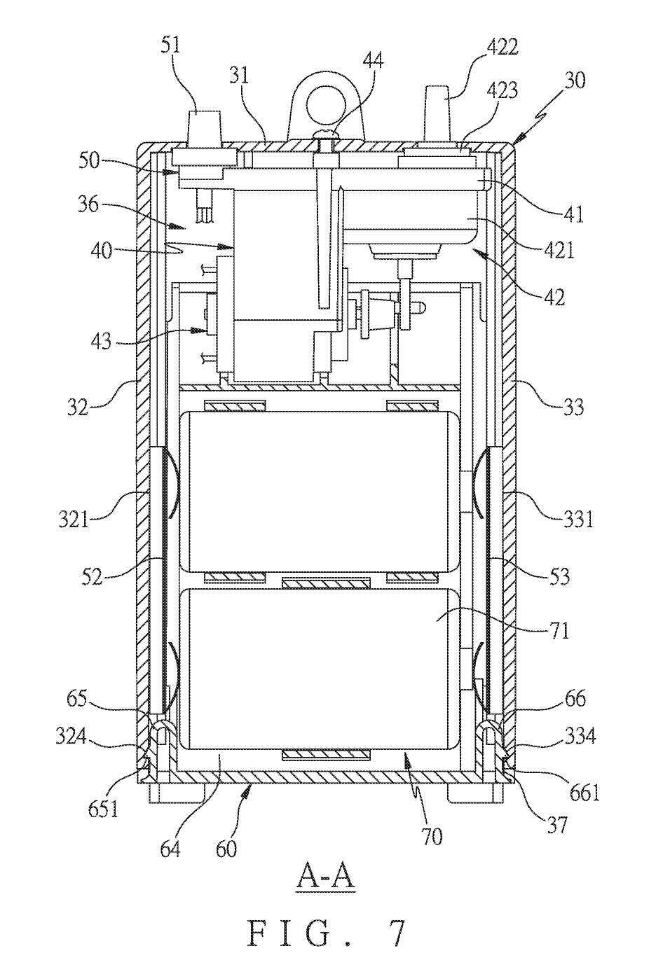

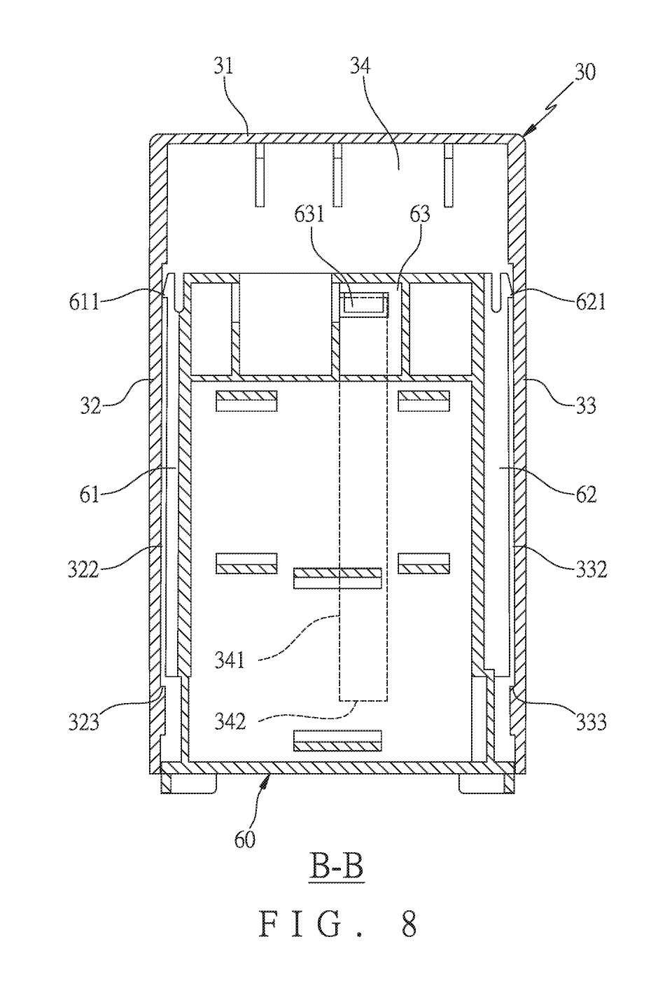

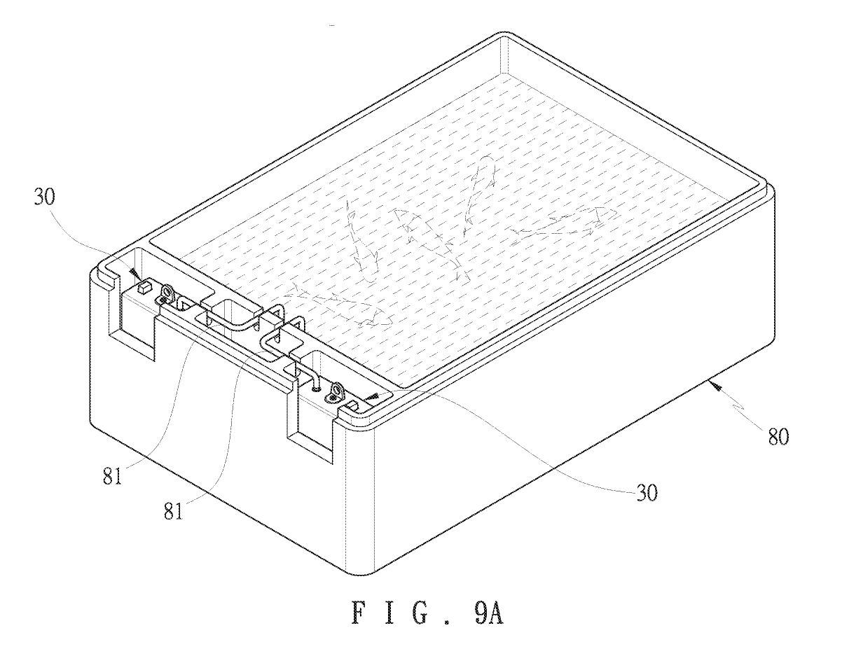

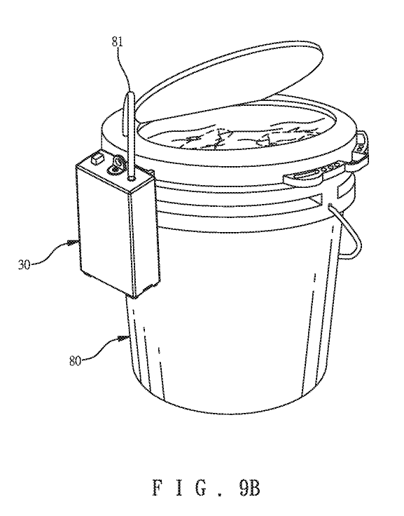

With reference to FIGS. 5-8, a direct current pump according to a preferred embodiment of the present invention comprises a case 30, a pumping module 40, a switch assembly 50, a slidable holder 60, and a battery assembly 70.

The case 30 is integrally molded and includes an opening defined on a bottom surface thereof. The case 20 is integrally formed as a cuboid and includes five plates, which includes a top plate 31 formed on a top surface thereof, a first side plate 32 and a second side plate 33 integrally connected to two sides of the top plate 31 respectively, a third side plate 34 integrally connected to the top plate 31, the first side plate 32 and the second side plate 33, and a fourth side plate 35 integrally connected to the first side plate 32 and the second side plate 33 and being locating opposite to the third side plate 34.

The case 30 has an accommodation chamber 36 defined by the top plate 31 and the first, second, third, and fourth side plates 32, 33, 34, 35 so as to receive the pumping module 40, the switch assembly 50, the holder 60, and the battery assembly 70 therein. The opening 37 of the case 10 defined on the bottom surface thereof communicates with the accommodation chamber 36.

The pumping module 40 is received in the accommodation chamber 36. The pumping module 40 has a supporting portion 41 on which a pump 42 and a motor 43 are fixed. The pump 42 has a cap 421 and an air exhaust tube 422 protruding out of the top plate 31 and the top surface of the case 30. The motor 43 is connected to and drives the cap 421 to pump air repeatedly so that the air is pumped and discharged outwardly via the air exhaust tube 422. Since the operational condition of the pump 42 and the cap 421 is already known in the art, further relevant remarks are omitted.

The pumping module 40 is received into the accommodation chamber 36 from the opening 37 of the case 30, the supporting portion 41 of the pumping module 40 is secured on the top plate 31 of the case 30 by using a screw bolt 44 so that the pumping module 40 is fixed to the case 30 in the accommodation chamber 36. The air exhaust tube 422 of the pump 42 extends and protrudes out of the top plate 31 and the top surface of the case 30. A water resisting ring 423 is fitted between the air exhaust tube 22 and the top plate 31 of the case 30.

The switch assembly 50 is received in the accommodation chamber 36 of the case 30 and is electrically connected to the motor 43 so as to control the operation of the motor 43. The switch assembly 50 is fixed on the supporting portion 41 of the pumping assembly 40. The switch assembly 50 includes a button protruding out of the top plate 31 and the top surface of the case 30 and includes a water resisting lid 51 arranged on the button of the switch assembly 50. Furthermore, the switch assembly 50 further includes two electrode connectors. One of the electrode connectors, the first electrode connector 52, is located on the first side plate 32, being electrically connected to the switch assembly 50. The other one of the electrode connectors, the second electrode connector 53, is located inside the second side plate 33, being electrically connected to the switch assembly 50. The first side plate 32 has a first groove 321 defined on an inner wall thereof so as to receive the first electrode connector 52. The second side plate 33 has a second groove 331 defined on an inner wall thereof so as to receive the second electrode connector 53.

The slidable holder 60 covers onto the opening 37 of the case 30. The slidable holder 60 is configured to receive at least one battery 71 of the battery assembly 70 so that the battery assembly 70 is carried by the slidable holder 60 to be received in the accommodation chamber 36 of the case 30. After the slidable holder 60 is covered onto the opening 37 of the case 30, two electrodes of the at least one battery 71 of the battery assembly 70 are electrically connected to the switch assembly 50 so as to supply power to the motor 43 of the pumping module 40. In this embodiment, the two electrodes of the at least one battery 71 of the battery assembly 70 are electrically connected to the first electrode connector 52 and the second electrode 53 of the switch assembly 50 respectively so as to supply power to the motor 43 of the pumping module 40.

The slidable holder 60 includes a first extension 61 extending from a first side thereof, a second extension 62 extending from a second side thereof, a connection plate 63 connected between the first extension 61 and the second extension 62, a receiving portion 64 configured to receive the battery assembly 70. The first side plate 32 of the case 30 has a first slot 322 formed on the inner wall thereof. A first shoulder 323 is arranged on the first slot 322 adjacent to the opening 37. The second side plate 33 of the case 30 has a second slot 332 formed on the inner wall thereof. A second shoulder 333 is arranged on the second slot 332 adjacent to the opening 37. The first extension 61 and the second extension 62 of the slidable holder 60 are slid into the first slot 322 of the first side plate 32 and the second slot 332 of the second side plate 33 individually, so that the slidable holder 60 can be pulled to slide in the accommodation chamber 36 of the case 30. When the slidable holder 60 slides into the accommodation chamber 36 and covers the opening 37, the two electrodes of the at least one battery 71 of the battery assembly 70 are electrically connected to the first electrode connector 52 and the second electrode 53 of the switch assembly 50 respectively.

To avoid a removal of the slidable holder 60 from the case 30, the first extension 61 has a first flexible hook 611 formed on an edge thereof. The first flexible hook 611 is retained in the first slot 322. The second extension 62 has a second flexible hook 621 formed on an edge thereof. The second flexible hook 621 is retained in the second slot 332. The first hook 611 is retained with the first shoulder 323 of the first slot 322, and the second flexible hook 621 is retained with the second shoulder 333 of the second slot 332, so that the removal of the slidable holder 60 from the case 30 is prohibited. In addition, the connection plate 63 of the slidable holder 60 has a third flexible hook 631. The third side plate 34 of the case 30 has a third slot 341 formed on an inner wall thereof. A third shoulder 342 is arranged on the third slot 341 adjacent to the opening 37. The third flexible hook 631 of the connection plate 63 is slid in the third slot 341 and is retained with the third shoulder 342, helping to support and to guide the slidable holder 60 to slide stably.

The slidable holder 60 includes a first flexible piece 65 formed in a U shape and located proximate to the first side plate 32. The first flexible piece 65 has a first retainer 651 formed thereon. The slidable holder 60 includes a second flexible piece 66 formed in a U shape and located proximate to the second side plate 33. The second flexible piece 66 has a second retainer 661 formed thereon. The first side plate 32 of the case 30 has a first recess 324 formed on the inner wall thereof adjacent to the opening 37. The second side plate 33 of the case 30 has a second recess 334 formed on the inner wall thereof adjacent to the opening 37. The first retainer 651 of the first flexible piece 65 of the slidable holder 60 engages the first recess 324 of the first side plate 32 of the case 30, and the second retainer 661 of the second flexible piece 66 engages the second recess 334 of the second side plate 33 of the case 30. The slidable holder 60 can therefore cover onto the opening 37 of the case 30. The two electrodes (i.e., a positive electrode and a negative electrode) of the at least one battery 71 of the battery assembly 70 are then electrically connected to the first electrode connector 52 and the second electrode connector 53 of the switch assembly 50 respectively so as to supply the power to the motor 43 of the pumping module 40. The switch assembly 70 is provided for turning on/off the motor 43. In other possible embodiment of the invention, the pumping module 40 may probably be secured to the slidable holder 60. In such cases, the air exhaust tube 422 of the pumping module 40 and the switch assembly 70 should still extend and protrude out of the top plate 31 of the case 30 after the slidable holder 60 covers the opening of the case 30.

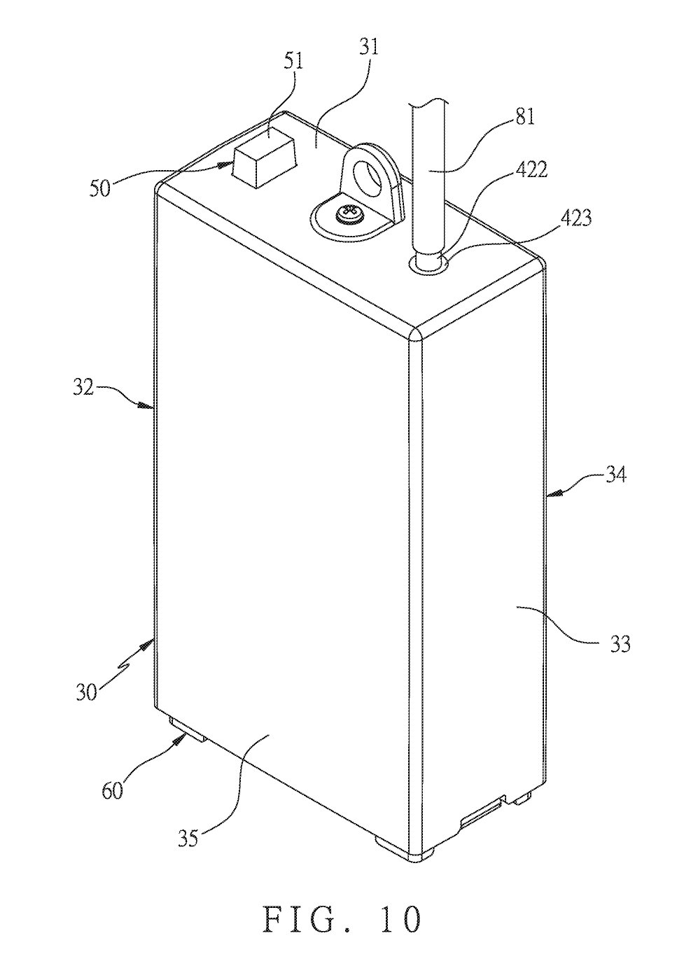

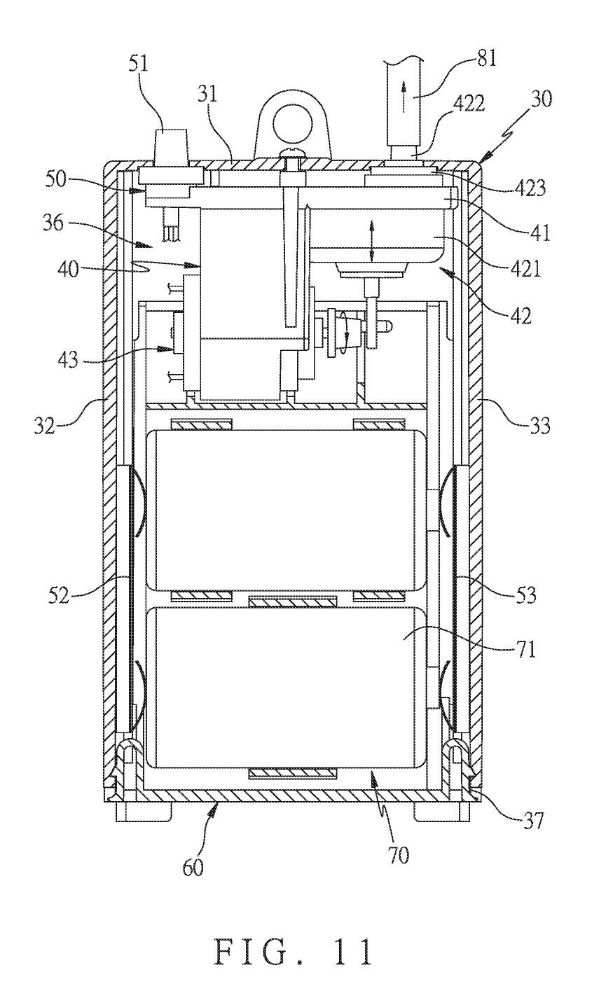

Referring to FIGS. 9-11, in general operation, the direct current pump is attached to an outer wall of a fish bucket 80. The air exhaust tube 422 of the pump 42 is connected to a pipe 81 which extends into the fish bucket 80. When the user fills the fish bucket 80 with water, the water may drench on the direct current pump. The water cannot pass through the top plate 31, the first side plate 32, the second side plate 33, the third side plate 35, and the fourth side plate 36 to flow into the case 30. Thereafter, fishes are put into the fish bucket 80. The motor 43 of the pumping module 40 may be turned on by using the switch assembly 50, driving the cap 421 of the pump 42 to pump the air repeatedly. The air is then pumped into the water contained in the fish bucket 80 via the air exhaust tube 422 and the pipe 81, providing oxygen to the water contained in the fish bucket 80.

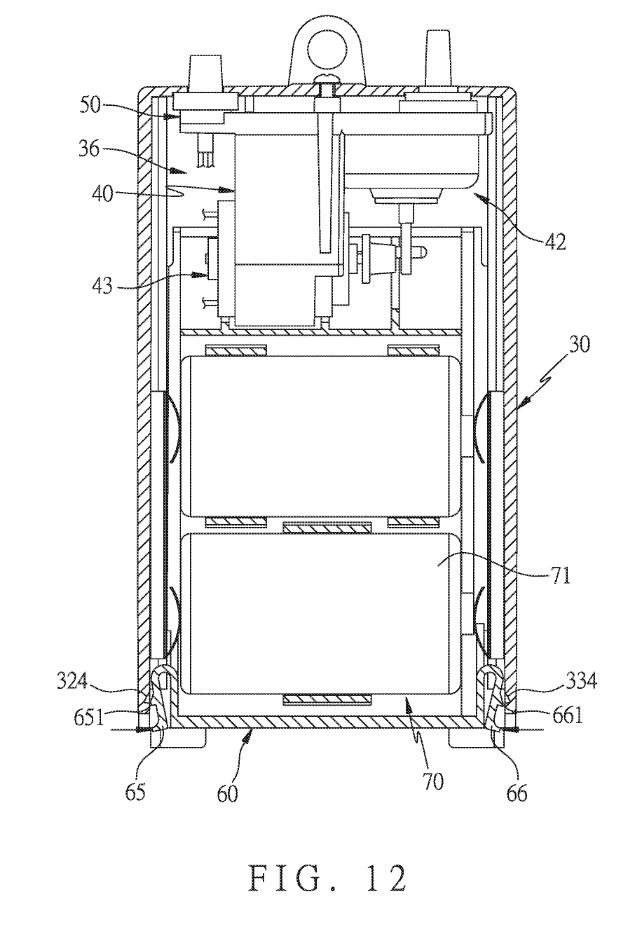

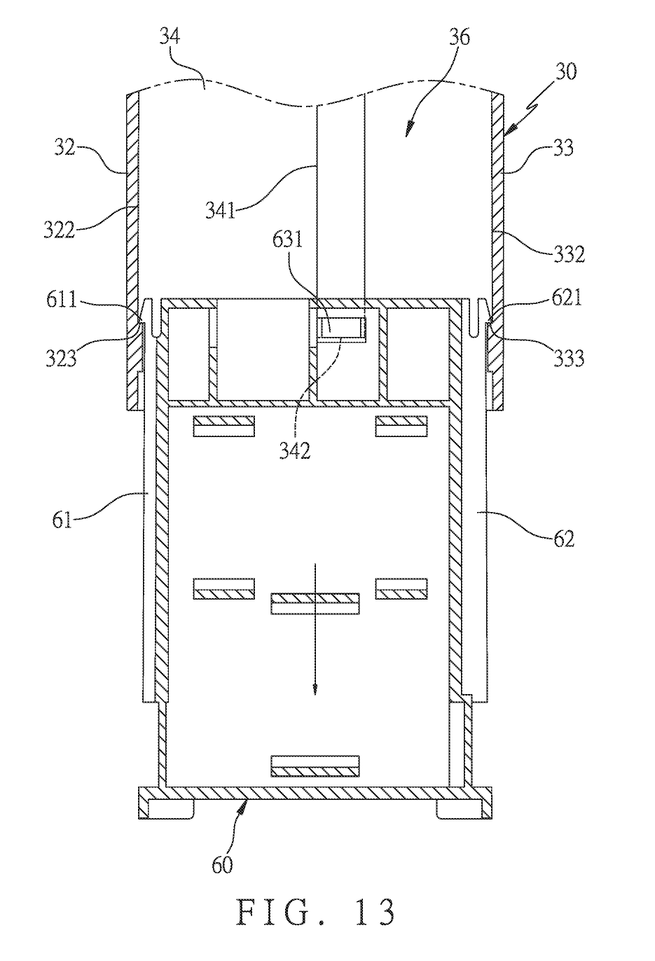

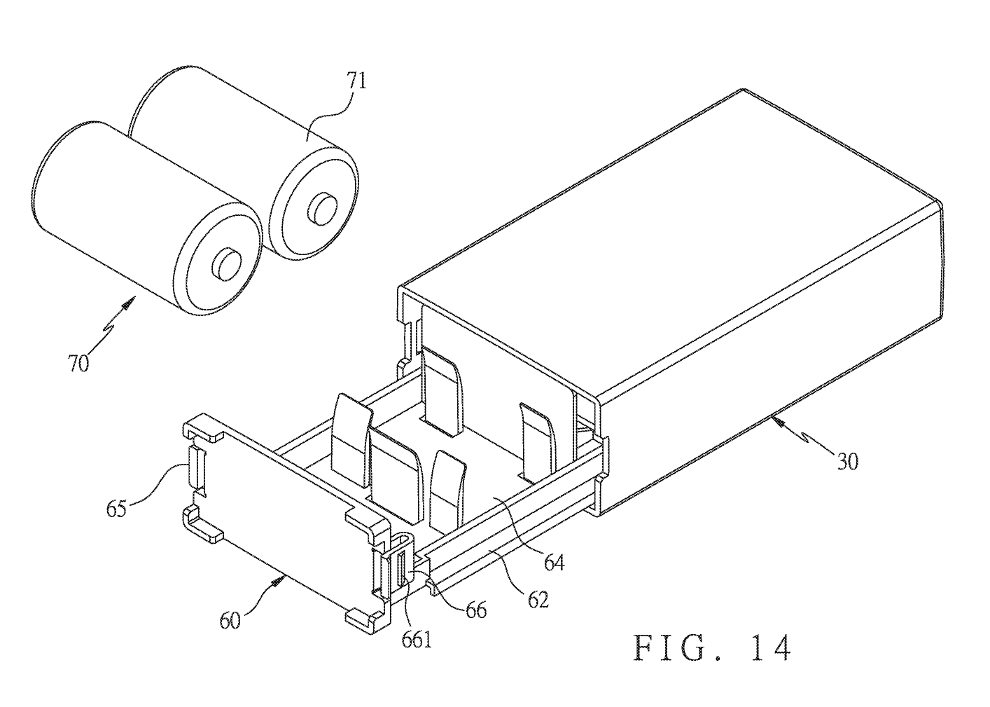

Please refer to FIGS. 12-14. When user would like to replace the battery assembly, the first flexible piece 65 and the second flexible piece 66 of the slidable holder 60 can be pressed inwardly, so that the first retainer 651 of the first flexible piece 65 is removed from the first recess 324 of the case 30, and the second retainer 661 of the second flexible piece 66 is removed from the second recess 334 of the case 30. The slidable holder 60 can then be pulled outwardly. In addition, the first shoulder 323, the second shoulder 333, and the third shoulder 342 of the case 30 engage the first flexible hook 611, the second flexible hook 621, and the third flexible hook 631 of the slidable holder 60 respectively, so that removal of the slidable holder 60 from the case 30 is avoided. The at least one battery 71 of the battery assembly 70 is detachable from the accommodation chamber 36 for being replaced by a new battery.

While the preferred embodiments of the invention have been set forth for the purpose of disclosure, modifications of the disclosed embodiments of the invention as well as other embodiments thereof may occur to those skilled in the art. Accordingly, the appended claims are intended to covering assembly all embodiments which do not depart from the spirit and scope of the invention.

What is claimed is:

1. A direct current pump comprising:
an integrally formed case, having a top plate, a first side plate, a second side plate, a third side plate, and a fourth side plate, the top plate formed on a top surface of the case, the first side plate and the second side plate connected to two sides of the top plate respectively, the third side plate connected to the top plate, the first side plate, and the second side plate, and the fourth side plate connected to the top plate, the first side plate, and a second side plate and being opposite to the third side plate, the case having an accommodation chamber defined therein, the case having an opening defined on a bottom surface of the case, and the opening communicating with the accommodation chamber;
a pumping module, received in the accommodation chamber of the case, the pumping module including a motor and a pump driven by the motor to pump air;
a switch assembly, received in the accommodation chamber of the case and electrically connected to the motor of the pumping module, the switch assembly including a button protruding out of the case; and
a slidable holder, covered onto the opening of the case and received in the accommodation chamber of the case, the slidable holder including a receiving portion adapted for a battery assembly to be received therein.

2. The direct current pump as claimed in claim 1, wherein the direct current pump further comprises a battery assembly received in the receiving portion of the slidable holder, the battery assembly is actuated by the slidable holder to be received in the accommodation chamber of the case, and the battery assembly is electrically connected to the switch assembly to supply power to the motor of the pumping module.

3. The direct current pump as claimed in claim 1, wherein the slidable holder includes a first extension extending from a first side thereof, a second extension extending from a second side of the slidable holder, and the receiving portion defined between the first extension and the second extension; the first side plate of the case has a first slot formed on an inner wall thereof and a first shoulder arranged on the first slot adjacent to the opening, and the second side plate of the case has a second slot formed on an inner wall thereof and a second shoulder arranged on the second slot adjacent to the opening, such that the first extension and the second extension of the slidable holder are slid into the first slot of the first side plate and the second slot of the second side plate individually so that the slidable holder is able to be pulled to slide in the accommodation chamber of the case.

4. The direct current pump as claimed in claim 3, wherein the first extension has a first flexible hook formed on an edge thereof and retained with the first slot, and the second extension has a second flexible hook formed on an edge thereof and retained with the second slot, such that the first hook is retained with the first shoulder of the first slot, and the second flexible hook is retained with the second shoulder of the second slot.

5. The direct current pump as claimed in claim 3, wherein the slidable holder includes a connection plate connected between the first extension and the second extension, the connection plate of the slidable holder has a third flexible hook, the third side plate of the case has a third slot formed on an inner wall thereof and a third shoulder arranged on the third slot adjacent to the opening, so that the third flexible hook of the connection plate is slid in the third slot and is retained with the third shoulder.

6. The direct current pump as claimed in claim 1, wherein the pumping module has a supporting portion to which the pump and the motor are fixed, wherein the pump has a cap and an air exhaust tube protruding out of the top plate of the case, and the motor is connected to and drives the cap to pump air repeatedly, so that the air is discharged via the air exhaust tube.

7. The direct current pump as claimed in claim 6, wherein the supporting portion of the pumping module is secured on the top plate of the case by using a screw bolt so that the pumping module is fixed in the accommodation chamber of the case, and the air exhaust tube of the pump protrudes out of the top plate of the case.

8. The direct current pump as claimed in claim 1, wherein the switch assembly includes a water resisting lid arranged on the button of the switch assembly.

9. The direct current pump as claimed in claim 1, wherein the switch assembly includes a first electrode connector received in the accommodation chamber and electrically connected to the switch assembly, and the switch assembly includes a second electrode connector received in the accommodation chamber and electrically connected to the switch assembly.

10. The direct current pump as claimed in claim 1, wherein the slidable holder further includes at least one flexible piece formed in a U shape and located proximate to the first and second side plates respectively, the at least one flexible piece has at least one retainer formed thereon respectively, and the case further has at least one recess formed on the inner wall thereof adjacent to the opening, such that the at least one retainer of the slidable holder engages the at least one recess of the case individually.
